(19) United States
(12) Patent Application Publication
(10) Pub. No.: US 2006/0247927 A1
(43) Pub. Date: Nov. 2, 2006

(54) Controlling an output while receiving a user input

(76) Inventors: Kenneth L. Robbins, Sudbury, MA (US); Eric William Burger, Amherst, NH (US)

Correspondence Address: FISH & RICHARDSON PC, P.O. BOX 1022, MINNEAPOLIS, MN, 55440-1022, US

(21) Appl. No.: 11/118,910

(22) Filed: Apr. 29, 2005

(51) Int. Cl. G10L 21/00

(52) U.S. Cl. 704/225

(57) ABSTRACT

While an output is presented to a user, an audio input that can include spoken input from the user is monitored. Presentation of the output is controlled while monitoring the audio input based on the monitoring. In the case of an audio output, the presentation can be controlled by attenuating the audio output according to the monitoring of the audio input. For example, a level of the audio output is reduced for continued presentation to the user after a desired signal is detected in the audio input. The output can include a prompt soliciting an input from a user, and the monitoring can include detecting the user's spoken input in the input audio, for example, estimating a certainty that the audio input includes the user's spoken input, or that such spoken input is in a desired grammar, such as in a desired list of commands or phrases. The approach is also applicable to video outputs.

### BACKGROUND

This description relates to controlling an output while receiving a user audio input.

In some systems, an audio output is played at the same time as an associated audio input is being received from a user. An example is in interactive applications in which an audio output prompt is played to a user while the system monitors an audio input that may include the user's spoken response to the prompt. An example of such an application uses Automatic Speech Recognition (ASR) to interpret speech in the input audio and allows the user to “barge in” or “cut through” and begin responding to an audio prompt before the prompt has been completed. When the user's speech is detected while the prompt is being played, the playing of the prompt may be aborted. Aborting the prompt can improve the accuracy of the speech recognizer by reducing the interference of the prompt in the input audio, and can make it easier for the speaker to speak, for example, because the prompt does not distract or otherwise interfere with his speech

ASR systems with barge-in can make errors determining that a user has spoken during barge in, for example, due to a loud non-speech sound in the background. One approach to dealing with such an error is to restart the playing of the prompt when the system determines that the input was not speech.

### SUMMARY

In one aspect, in general, an output is presented to a user. While the audio output is presented to the user, an audio input that can include spoken input from the user is monitored. Presentation of the output is controlled while monitoring the audio input. The presentation of the output is determined based on the monitoring of the audio input.

Aspects can include one or more of the following features.

The output includes an audio output, and controlling the presentation of the output includes controlling a level of the audio output. Controlling the presentation of the output can include attenuating the audio output according to the monitoring of the audio input. Attenuating the audio output according to the monitoring of the audio input can include reducing a level of the audio output for continued presentation to the user after a desired signal is detected in the audio input.

Attenuating the audio output includes attenuating the audio output according to a measure of presence of a desired signal in the monitored audio input. The measure can include a confidence of presence of speech or can include a confidence of presence of desired speech.

The output includes a visual output, and the controlling the presentation includes controlling a visual characteristic of the visual output.

The output includes a solicitation of spoken input from a user. The output can include an audio prompt soliciting the spoken input from a user and can include a visual display to the user.

Monitoring the audio input includes detecting the user's spoken input in the audio input. Detecting the user's spoken input can include estimating a certainty that the audio input includes the user's spoken input.

Controlling the presentation of the output includes controlling a presentation characteristic in a changing profile over time. The output can include an audio output and controlling the presentation characteristic of the output can include attenuating the audio output in a changing profile over time. The output can include a visual output and controlling the presentation characteristic of the output includes making a transition in the visual output in a changing profile over time. Making the transition can include fading between one visual output and another visual output.

Controlling the presentation of the output includes repeatedly adjusting a presentation characteristic in response to the monitored audio input. Controlling the presentation can include adjusting the presentation characteristic at regular intervals.

Monitoring the audio input includes computing a measure of presence of the user's spoken input in the audio input. Computing the measure of presence of the user's spoken input in the audio input can include computing a measure that the user's spoken input is in a desired grammar. The desired grammar can include a set of commands.

Controlling the presentation of the output includes processing the measure of the presence of the user's spoken input to determine a quantity characterizing a presentation characteristic of the output. Processing the measure of the presence can include filtering the measure.

Computing the measure of presence of speech include applying a speech recognition approach to determine the measure of presence of speech.

The output includes an audio output, and controlling the characteristic of the output includes increasing a level of the audio output for at least some audio inputs.

In another aspect, an output is controlled while receiving a user input. An output is presented to a user and an input from the user is monitored. Presentation of the output to the user is controlled while monitoring the input. The presentation of the output is determined based on the monitoring of the input. At least one of the output to the user and the input from the user includes visual information.

Aspects can include one or more of the following features.

Monitoring input from the user includes monitoring visual information associated with the user, for example, including facial information or gesture information of the user. Such information can include, without limitation, hand or arm movements, sign language, lip reading, and head or eye movements.

Controlling presentation of the output includes controlling presentation of visual information to the user.

One or more of the following advantages may be achieved.

Making a gradual transition in the output according to a changing profile over time can be less interfering with the input process while providing feedback to the user base monitoring of input from the user.

Making a gradual transition in the output, for example, based on the detection of a triggering event (or determining a degree of confidence of the presence of the triggering event), can allow the system to reverse the transition if it determines that it was a false detection. For example, such a gradual transition and reversal of the transition can be useful when background noise is falsely detected as the user speaking. Such reversing of a gradual transition can be less disruptive than making and then reversing abrupt transitions in the output.

Attenuating the prompt can provide an advantage over continuing to play the prompt at the original volume by interfering less with the input process, for example, by distracting the user less or by introducing less of an echo of the prompt in the input audio.

Continuing to play a prompt at an attenuated level can provide an advantage over aborting the prompt entirely by providing continuity which can be important if the speech was detected in error. Also, an error that results in attenuation of a prompt can be less significant than an error that causes a prompt to be aborted. Therefore, a prompt can be attenuated at a relatively lower confidence that the user has begun speaking as compared to the confidence at which it may be appropriate to abort the prompt.

It can also be advantageous to provide additional prompt information (at an attenuated level) even after the user has begun speaking.

Attenuating the prompt can provide feedback to a user that the system believes that he has started speaking. This may reduce the instances in which the user restarts speaking or speaks unnaturally as compared to when a prompt continues playing at its original level.

Other features and advantages of the invention are apparent from the following description, and from the claims.

### DESCRIPTION

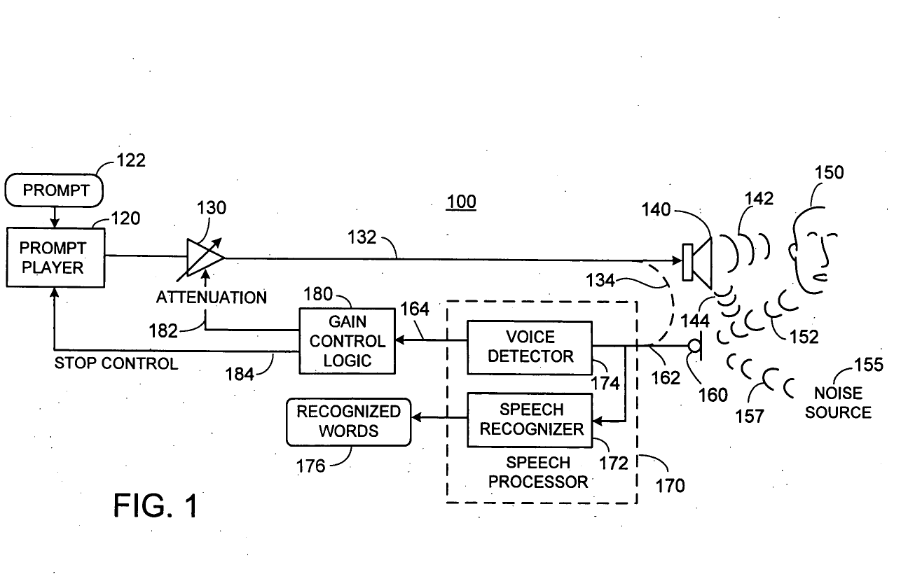

FIG. 1 is a block diagram of an audio system.

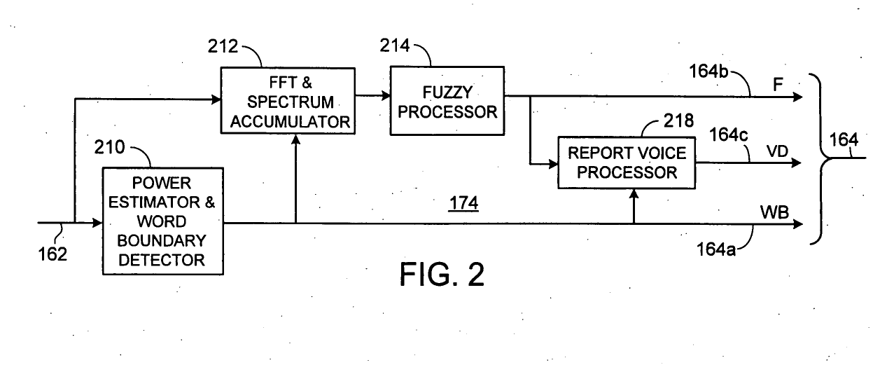

FIG. 2 is a block diagram of a voice detector.

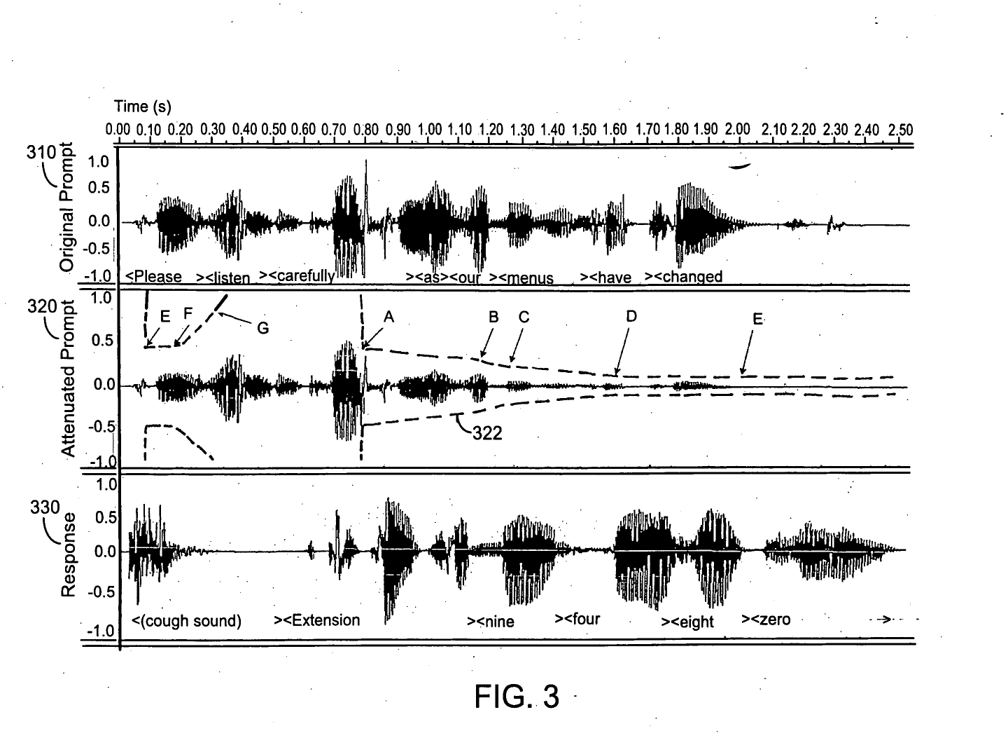

FIG. 3 is a graph including signal levels.

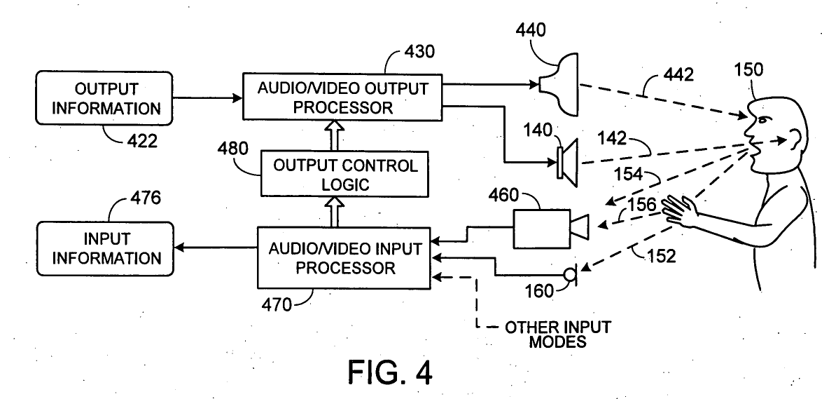

FIG. 4 is a block diagram of an audio/video system.

Referring to FIG. 1, an audio system 100 is configured play a prompt 122 to a user 150 and to accept spoken input 152 from the user in response to the playing of the prompt. The system 100 implements a form of barge-in processing that accepts and processes input audio 162 including the spoken input 152 even if the user begins speaking while the prompt is still playing. The system makes use of a prompt gain control approach in which processing of the input audio determines an attenuation factor 182 as it receives the input audio 162. The attenuation factor 182 forms a presentation characteristic for the output prompt and includes information that characterizes a degree to which the prompt 122 should be attenuated, for example, taking on a value in a continuous range of multipliers to apply to the energy level of the prompt 122. Some implementations of the barge-in approach of the system 100 progressively attenuate the prompt as the system becomes increasingly certain that the user has indeed begun speaking.

In the system 100, the prompt 122 may be stored as a digitized waveform or as data for use by a speech synthesizer and is used by a prompt player 120 that outputs a standard signal-level version of the prompt. The output of the prompt player 120 passes to a gain component 130 that applies the attenuation factor 182, which is provided as an output of a gain control logic (GCL) component 180. The attenuated prompt 132 passes to a speaker 140 that converts the prompt to an acoustic form 142, which is heard by the user 150.

The system has a microphone 160 that is used to receive the user's spoken input 152. This microphone may also receive acoustic input 157 from a noise source 155, and depending on the configuration of the speaker 140 and the microphone 160, may also receive a version (e.g., an attenuated acoustic version) of the prompt itself 144. In some implementations of the system, the prompt signal may also couple into the microphone signal, for example, through electrical coupling 134. In one example of the system 100, the microphone 160 and speaker 140 are parts of a user's telephone handset and the other components shown in FIG. 1 (e.g. speech processor 170 and gain component 130) are coupled to the handset through a telephone network (not shown in FIG. 1). In implementations in which the microphone and speaker are part of a telephone, the electrical coupling of the prompt into the audio input signal may be due to the hybrid converter in the user's telephone.

The microphone signal 162 passes from the microphone 160 to a speech processor 170. The speech processor includes a voice detector (VD) 174 that computes a number of quantities that together characterize a certainty, or other type of estimate, that the microphone signal 162 represents the user speaking. The speech processor 170 also includes a speech recognizer 172 that outputs recognized words 176 that it determines were likely spoken by the user. Note that although drawn as two separate elements, the voice detector 174 and the speech recognizer 172 can either be totally separate or can share components in different implementations.

The gain control logic 180 receives the information output from the voice detector 174 and computes the attenuation factor 182 to apply to the gain control element 130. In general, the gain control logic 180 determines the attenuation factor in order to attenuate the prompt more as the certainty that the input includes the user's speech increases. Alternatively, the certainty on which the attenuation factor is based can depend of a certainty that the user has spoken words or commands in a specific lexicon, or has uttered a word sequence that is accepted by a specific grammar, which constrains or specifies desired or acceptable words or word sequences. To the extent that certainty that the user is speaking increases as more of the input signal is processed, the volume of the prompt gradually decreases. With a sufficiently high certainty, the gain control logic 180 provides a control signal to the prompt player 120 to stop playing or entirely attenuate the prompt.

For some microphone input signals 162, the certainty or estimate that the signal includes the user's speech may increase and then decrease. For example, a noise from the noise source 155 may be loud enough to appear to the system to be the beginning of speech, but then not continue or even if it continues may not have speech-like characteristics. In such a scenario and for at least some implementations, the certainty of speech as computed by the voice detector 174 may decrease after an initial period, for example, after the noise has passed. As a result of such a pattern of increasing and then decreasing certainty of speech, the gain control logic 180 computes the attenuation factor 182 to have a value such that the prompt is briefly attenuated but then may return to a normal level after the noise passes until speech is once again detected. A similar scenario can occur when the user causes the noise, for example, by the user coughing or by speech being fed back from the prompt input to the input audio. Any time profile of variation of certainty of speech can be accommodated by the gain control logic 180.

The voice detector 174 and the gain control logic 180 can be implemented using a variety of different techniques. In a first implementation of the system, the voice detector applies a short-time average (e.g., 50 millisecond average) to the input energy to determine the certainty that speech is present. This certainty is mapped to an attenuation factor by the gain control logic 180 such that when the input has energy at a higher level and sustained longer the prompt is more attenuated. Numerous other approaches to computing a certainty that speech is present have been proposed and could be used in alternative implementations of the voice detector 174. Such approaches are based, without limitation, on factors such as energy variation, spectral analysis, and zero crossing rate. Other speech detection approaches that can be used are based on cepstral analysis, linear prediction analysis, pattern recognition or matching, and speech modeling such as based on Hidden Markov Models (HMMs).

In some implementations of the system, the gain control logic 180 computes a monotonic mapping between the estimate of speech produced by the voice detector 174 and the attenuation factor 182 applied to the gain element 130. In these implementations in which the voice detector 174 outputs the averaged energy of the input signal, the gain control logic computes the attenuation to be proportional to the averaged energy

In some implementations of the system, the gain control logic 180 applies a time-domain filtering to its input, for example, smoothing according a time constant or other form of filtering. The time constant of such smoothing can be different for increases in the input level than for decreases, for instance providing faster response to onsets of speech with more gradual response to decreases in certainty of speech. The gain control logic can also or alternatively use state-based processing, for example introducing hysteresis such that after the prompt is attenuated to a particular level, the certainty of speech must fall below a threshold for the prompt to increase in level. In some implementations, the gain control logic implements limits on the amount of attenuation, for example, to guarantee at least a minimum level at which the prompt is played and to limit the level to a maximum level.

A particular implementation of the voice detector 174 is based on components described in U.S. Pat. No. 6,321,194, “Voice Detection in Audio Signals,” which is incorporated herein by reference. Referring to FIG. 2, the microphone signal 162 passes to a power estimator and word boundary detector 210, which output a binary signal WB 164a indicating whether the signal power is above a predetermined level. The signal 162 also passes to an FFT and spectrum accumulator module 212. The spectrum accumulator accumulates the energy in each of a set of frequency bands, for example, in each of 128 equal width frequency bands. When the word boundary detection signal indicates a start of a word (i.e., crossing of the power level from below to above the power threshold), the accumulated values in each of the bands are reset to zero. The energy values are accumulated during the period that the word boundary detector 210 indicates a word is present, and the accumulating stops when the detector indicates an end of a word. The accumulating energy values are passed from the FFT and spectrum accumulator module 212 to a fuzzy processor 214. The parameters of the fuzzy processor 214 are estimated based on a training set of audio inputs in which the presence of speech input is marked. Generally, the output F 164b of the fuzzy processor 214 is greater if the accumulated spectral energies and corresponding accumulated word duration are more indicative of a spoken word being present in the input signal 162. The range of outputs of the fuzzy processor 214 is a continuous interval from 0.0 to 1.0. The output of the fuzzy processor F 164b forms another component of the signal 164 that is passed to the gain control logic 130. The output of the fuzzy processor 214 is passed to report voice processor 218, which outputs a binary value VD 164c. During a word (as indicated by the WB signals 164a), the VD 164c value indicates if F 164b exceeds a predetermined threshold. The value of VD 164c is sampled at the end of each word as indicated by WB 164a and held until the next word is detected. The three output values (WB 164a, F 164b, and VD 164c) together comprise signal 164 that is passed to a compatible version of the gain control logic 180.

A particular version of the gain control logic 180 that is compatible with the version of the voice detector described above makes use of the three components of the output of the voice detector. While the word boundary detector output of the voice detector 174 is initially 0 (i.e., a “word” is not detected), the gain is 1 and there is no attenuation of the prompt. Upon the transition of the word boundary detector output to 1, prompt level is reduced by a factor of N (a configurable value between 0 and 1). For example, the value of N can be chosen to be 0.5, which corresponds to an attenuation of 6 dB. That is, the amplitude of the prompt is multiplied by (1−N). This attenuation represents the first initial gain adjustment based on the earliest and typically most uncertain estimate of speech being present. The factor N is chosen so that the user is able to discern the reduction and therefore is cued to the fact that the system is noticing the barge-in and should be chosen to be as small as possible to yield this effect so that false inputs have a minimized effect. After the initial attenuation until the end of word boundary is detected, the gain tracks track the output F 164b of the fuzzy processor 214 as follows: gain=(1−N)*(1−F). A floor function is applied such that the gain does not drop below a configurable minimum value (e.g., 0.1 or −20 dB). Once the end of word boundary is detected, then the binary output VD 164c is used directly as follows. If the VD indicates that voice was not present, the gain is increased to 1 at a configurable rate M (e.g., 6 dB/0.14 second) to provide a full-level prompt, while if the output indicates that voice was detected the gain is set to zero (rendering the prompt inaudible), or the playing of the prompt is aborted entirely.

Some approaches to implementing the voice detector 174 use components of the speech recognizer 172. For example, some types of speech recognizers compute a quantity during the course of determining the most likely words spoken that is related to their confidence that particular words or speech-like sounds were uttered. For example, a speech recognizer configured to recognize sequences of spoken digits can have an output that characterizes a certainty that some digit is being spoken. That output of the speech recognizer is used as the input to the gain control logic that determines the gain to apply to the prompt.

In one use of a speech recognizer to determine a certainty that desired speech has been detected, the speech recognizer outputs a hypothesized word or word sequence along with a score that characterizes the certainty that the hypothesis is correct. In an implementation of the system, the prompt is either attenuated or aborted based on the score. For example, if the speech recognizer outputs a relatively poor score, the prompt is attenuated less than for a relatively better score. For a sufficiently good score, the prompt is aborted. In this way, a false alarm gives the user the opportunity to continue hearing the prompt, but also provides some feedback that the speech recognizer has processed his input.

In another user of a speech recognizer to determine a certainty that desired speech has been detected, the speech recognizer includes the capability of reporting a score that the input speech is present even before the audio input for a complete command or acceptable word sequence has been accepted by the speech recognizer. For instance, the speech recognizer outputs a score that it is at a particular point or in a particular region of a speech recognition grammar. As one example, the speech recognition grammar includes an initial silence or background sound model, followed by models for desired words, and the speech recognizer is configured to report when and/or how certain speech is present based on an estimate that the audio input that the initial silence or background noise has been completed. As another example, if the speech recognizer is based on templates of desired words or phrases, the speech recognizer can output a degree of match to the templates, for example, outputting a time averaged degree of match to the templates.

A hybrid approach can also be used in which the output of a speech recognizer is combined with other forms of speech detection, for example, applying energy-level based forms of voice detection initially and relying on the output of the speech recognizer as certainty of the speech recognizer increases.

In another hybrid approach, a first voice detector is used to provide a first level of attenuation of the output, while a second voice detector is used to provide further attenuation. As an example, an energy-based voice detector is used to provide attenuation that maintains the prompt at an understandable but noticeably attenuated level, while a speech recognition-based voice detector provides further attenuation as desired speech is detected or as a complete command is hypothesized by the speech recognizer.

Rather than mapping the confidence of speech to an attenuation level, the confidence of speech can be mapped to rate of change in the prompt level or attenuation rather than an absolute level or attenuation. As an example, low confidence causes no attenuation, medium confidence scores cause a modest decay rate, higher confidence scores cause the highest decay rate, and scores above a certain threshold cause the estimator to issue the stop prompt command 184

Referring to FIG. 3, an example of application of the system to an input signal is illustrated with three time-aligned plots of audio signals. The horizontal axis represents time (marked in seconds) and the vertical axis of each plot represents a linear signal amplitude in the range from −1 to +1. A first plot 310, labeled “Original Prompt,” is a recording of a section of a prompt that says “Please listen carefully as our menus have changed.” The plot is annotated with the text which is roughly aligned to the actual signal. The word starts at the open angle bracket ‘<’ and is complete by the closing angle bracket ‘>’. A second plot 320, labeled “Attenuated Prompt,” shows what the original prompt after being attenuated when presented with the input signal shown in a the third plot 330, which is labeled “Response.” In the second plot 320, the dashed line 322 represents an amplitude envelope that results from the attenuation by the gain control logic.

In the second plot, the “Response” input audio signal is annotated with the contents of the signal in the same manner as the Original Prompt is annotated. The contents of the Response includes a cough sound followed by the spoken phrase “Extension nine four eight zero.”

Configurable parameters of the gain control logic for the example shown in FIG. 3 are an initial attenuation of N=0.5 (−6 dB) and a rate of gain increase of M=6 dB/0.14 second.

Referring to the example scenario of the plots in FIG. 3, as the prompt begins, the user coughs. The system detects the energy burst from the cough and immediately reduces the gain by N (0.5 or 6 dB). This is shown at point E on the amplitude envelope 322 of plot 320. By point F, the system has estimated that the input signal was not a speech input and then begins returning the gain back to 1 at a rate M (6 dB per 0.14 seconds). At the time of point G, the gain is at 1 where it remains until point A.

Therefore this “cough” event did cause the system to react by reducing the gain, but it did not cause the prompt to stop playing and the volume was restored quickly when it was determined that the input was not speech. Listeners comparing the audio output for the time period before point A might not be able to perceive the difference between the original prompt and the attenuated prompt since the total energy reduction is limited.

At time point A, the word boundary detector again triggers and which again reduces the gain of the prompt by N. The voice detector continues to track the input and produce estimates that indicate increasing certainty that the input signal is valid speech. By point B, the volume has been reduced from −6 dB to −9 dB. By point C the volume has been reduced to −12 dB. Finally by point D, the volume has been reduced to −20 dB. Since the floor value for this configuration is −20 dB, the volume stays at this level until the prompt is fully stopped based on a final voice barge-in determination.

Listeners may note that the volume after point A is clearly reduced and this provides the feedback to the user that the system has recognized that the user is speaking and that volume is at a low enough level that the caller does not feel like he is competing with the prompt source. Further, at all times after point A, including through to point E, the prompt is audible and intelligible.

The plots in FIG. 3 do not show a final stopping of the prompt. Depending on the tuning of the system, this could occur at any time after point A. For example, a threshold setting of the report voice processor 218 of the voice detector 174 can determine how certain the voice detection process must be in order to completely attenuate the prompt. In this example, such complete attenuation could occur, for example, at points C, D or E, depending on the threshold. In this example, for one setting of the threshold, the prompt would be completely attenuated just after the word “Extension” had been spoken or 0.63 seconds after the user started speaking, resulting in a full volume overlap of only 0.20 seconds (roughly the time to say the “ex” in “extension”) and a noticeably reduced volume for the remaining 0.43 seconds (roughly the time to say the “tension” part the word “extension.”

The approaches described above can be applied to various configurations of audio systems. As introduced above, the speaker 140 and microphone 160 can be part of a telephone device at a user's location, while the speech processor 170 and other components can be part of an audio system that is remote from the user. Such a system can be used, for example, in an automated telephone system in which the user is prompted to provide particular information in an overall call flow. The approach can also be applied to devices that integrate the audio processing including the voice detector 174, gain control logic 180 and gain component 130. For example, a portable telephone may incorporate these components and optionally the speech recognizer 172 within the device. The approach can also be applied to computer-workstation based speech recognition systems.

In another version of the system, the control of the attenuation level of an audio output is controlled at least in part by an application that processes the input audio, for example, by processing the output of a speech recognizer. As an example of such a system, the application determines whether the word sequence is a desired word sequence based on application-level logic, and provides a signal back to the gain control logic to attenuate the prompt if the audio input is of the type that is desired.

Although described above in the context of a speech recognition system, the approach is applicable in other audio processing systems in which a potentially interfering signal is attenuated as an information bearing signal is detected. For example, the system may have the function of recording a user's input, such as in a telephone message system. In such a system, the volume of an output prompt may be varied according to the detection of desired speech in the input signal, without necessarily applying a speech recognition algorithm to the input, while it is accepted and optionally stored by the system. The user's spoken input is not necessarily associated with the output audio, but the level of the output audio is nevertheless attenuated according to the certainty that the user is providing desired spoken input. As another application of the approach, an audio conference system controls the level of the output, for example, from remote participants, based on a confidence that an input signal includes speech rather than background noise. In such an example, the output from the remote participants can be attenuated when local participants are speaking.

The approaches described above may also be used in conjunction with approaches that are designed to mitigate the presence of the prompt output in the input signal. Such presence can be due to acoustic coupling between the speaker 140 and the microphone 160 and may be due to electrical coupling, for example, due the electrical characteristics of the system (e.g., as a result of a hybrid converter in the user's telephone). An example of such an approach includes an echo canceller that removes the effect of the prompt (e.g., subtracts the echoed prompt) in the input signal. By attenuating the output prompt volume, the reflected (echoed) prompt present in the input signal is reduced and increases the signal to noise ratio (SNR), which can improve the echo canceller performance and the speech recognition performance.

Referring to FIG. 4, a version of the system is used with video input and/or output, optionally in conjunction with audio input and output. In the example shown in FIG. 4, both input and output have audio and video components, and the input (and possibly the output) can have other modes of input, such as keyboard, mouse, pen, etc. In addition to the speaker 140, which presents an audio signal 142 to the user 150, a video display 440 (or other visual indicator, such as lights etc.) presents a visual signal 442 to the user. On input, the microphone 160 accepts an audio signal 152, which generally includes the user's speech, and a camera 460, or other video or presence sensor (e.g., a motion detector), accepts signals that relate to the user's motions and/or facial 154 or manual 152 gestures.

In general, the system illustrated in FIG. 4 enables presenting of a gradual change in the audio and/or the video output in response to monitoring of the user's audio and/or video input. An example of a gradual change in the visual output is a transition from one visual display to another based on a degree of confidence that the user has begun input to the system as determined based on monitoring of the audio and/or video input. An example of a gradual change in the audio output is a change in attenuation of the output based on the monitoring of the audio and/or video input.

Output information 422 is passed through an audio/video output processor 430 to the video display 440 and speaker 140. Various type of presentations can be used. As one example, the information that is output includes a graphical menu presented on the video display 440, optionally in conjunction with an audible prompt that may inform the user what the option on the menu are, or what commands can be spoken in the context of that menu. As another example, the information that is output includes an audio prompt and a corresponding graphical presentation, such as a synthesized or recorded image of a person (or cartoon, avatar, icon) “speaking” the prompt, or an image of a hand presenting the prompt using sign language (e.g., American Sign Language, ASL).

Audio/video output processor 430 implements one or more of a number of capabilities. Audio information can be attenuated as described, above. Furthermore, audio (and its corresponding video, for example, if synchronized) can be modified in time to change a rate of presentation. The processor 430 can implement various modifications of video presentations. As one example, the intensity of graphics can be modified, for example, fading a menu off its background, or making a gradual transition from one image to another (e.g., from a selection menu to a graphic associated with one of the selections in the menu). As another example, the processor 430 can alter characteristics of a presentation of a person speaking corresponding audio information. Such presentation characteristics can include gestures such as nodding or bowing the head, and facial expressions that may indicate understanding, confusion, elicitation of input, etc. If the presentation includes more than a face, the characteristics of presentation can include body gestures, such as hand motions.

Audio and video information that is received from the user 150 can include audio that includes the user's speech, as well as information related to the user's physical movements and expressions. For example, relevant aspects of the video input can include the user's facial expression, the user's lip motions (e.g., for lip-reading), and head motions (such as nodding yes or no), as well as hand motions, such as the user raising the palm of a hand in a “stop” gesture or the user presenting input using sign language.

The audio/video input processor 470 implements one or more of a number of capabilities. In addition to the audio processing capabilities described above in the context of voice detection, the processor 470 includes an image processor that takes the output of the camera 460 and detects visual inputs and cues from the user 150. The processor 470 can include, for example, one or more of a facial expression recognizer, a lip reader, a head motion detector, an eye motion tracker, an automated sign language recognizer, and other image processing components.

An output control logic 480 implements functions that are analogous to those performed by the gain control logic 180 in the audio voice-detection examples presented above. In this audio/video example, the output control logic 480 receives control signals from the audio/video input processor 470 that relate to both the audio signal from the microphone 160, such as the certainty that the user has begun speaking, as well as to the video signals received from the camera 460. For example, the control signals can indicate the presence of predefined types of gestures (e.g., acknowledgement nod, looking away, confusion, “stop”) or certainty of presence of recognized visual input (e.g., automatic lip reading or automatic sign language recognition.)

Based on its control inputs from the audio/video input processor 470, the output control logic 480 sends control signals to the audio/video output processor 430. As one example, upon detection of input speech (or other mode of user input) the video would not be immediately stopped or switched, but rather would change a presentation characteristic of the video output, for example making a transition from the video output in relation to the barge-in estimate. Types of transitions include a gradual fade to black (instead of a switch to black), a dissolve to another video source (still or moving) or any other transition effect. For example, a graphical display may show an output that includes menu of choices that can be spoken, and the menu is fades away as speech is detected, and the fading can be reversed when the certainty of speech goes does, such as when a cough is erroneously detected as speech. Similarly, versions of the approaches described above control a visual cue that is added to a video output to indicate that input speech has been heard. Such a cue can be an icon (appears during barge-in or not, or switches from one icon to another). This cue could be a continuous indicator, such as a meter or bar graph showing a threshold where barge-in is certain. This cue could be an avatar/agent character that reacts in a progressive gradual manner to the input audio and thus provides a visual cue that the system has detected speech, without necessarily providing only a binary indicator of speech detection. Whatever visual cue is used, it optionally persists beyond the final determination of barge-in for at least some period of time. More generally, the control signals generated by the output control logic can include various signals that stop the audio/video output or affect one or more presentation characteristics, such as the degree of fading or transition of a video image, a presentations (e.g., speaking rate), or cause presentation of particular gestures, such as an acknowledgement nod.

The output control logic in general implements procedures so that when the inputs from the user indicate that he or she begun presenting input to the system, for example, by speaking of nodding in response to the audio and/or video output, the output modified to provide feedback that represents the degree to which the system is certain that the user is presenting input, for example, by attenuated, faded, slowed down, presented with an “understanding” gesture or expression etc., in the output to the user.

In addition to or as an alternative to modifying the output presentation to provide feedback or an indication that the system has begun to detect the user's input, the control logic sends control signals to the output processor 430 to reduce the interfering effect of the output to the user. Example can include attenuation of audio output, fading of visual output, reducing the size of a graphic presentation (zooming out), reducing the degree of animation of a face that is speaking the output.

Versions of the approaches described above can be used in conjunction with video output instead of or in combination with audio output. For example, in addition to or rather than attenuating a prompt, the approach controls video output behavior.

The system can be implemented using analog representations of the signals, digitized representations of the signals, or a combination of both. In the case of digitized signals, the system includes appropriate analog-to-digital and digital-to-analog converters and associated components. Some or all of the components can be implemented using programmable processors, such as general-purpose microprocessors, signal processors, or programmable controllers. Such implementations can include software that is stored on a computer-readable medium, such as on a magnetic disk, in a read-only-memory, non-volatile memory (e.g., flash memory), or the like. The instructions in that software cause a computer processor to implement some or all of the functions described above. The functions can be hosted on a single device or at a single location, or may be distributed over many devices (e.g., computers) and/or distributed over several locations (e.g., the speech processor 170 at one location and the gain control logic 180 at another location). In some implementations, multiple speech processors 170 are applied to a single input. For example, multiple voice detectors 174 and/or multiple speech recognizers 172. Either the speech processor 170 or the gain control logic 180 is then responsible for combining the multiple inputs in order to create a single attenuation factor 182.

Other embodiments are within the scope of the following claims.

What is claimed is:

1. A method for audio processing comprising:
monitoring an audio input that includes spoken input from a user; and
controlling presentation of an output to the user while monitoring the audio input, the presentation of the output being determined based on the monitoring of the audio input.

2. The method of claim 1 wherein the output includes an audio output, and controlling the presentation of the output includes controlling a level of the audio output.

3. The method of claim 2 wherein controlling the presentation of the output includes attenuating the audio output according to the monitoring of the audio input.

4. The method of claim 3 wherein attenuating the audio output according to the monitoring of the audio input includes reducing a level of the audio output for continued presentation to the user after a desired signal is detected in the audio input.

5. The method of claim 3 wherein attenuating the audio output comprises attenuating the audio output according to a measure of presence of a desired signal in the monitored audio input.

6. The method of claim 5 wherein the measure comprises a confidence of presence of speech.

7. The method of claim 5 wherein the measure comprises a confidence of presence of desired speech.

8. The method of claim 1 wherein the output includes a visual output, and the controlling the presentation includes controlling a visual characteristic of the visual output.

9. The method of claim 1 wherein the output includes a solicitation of spoken input from a user.

10. The method of claim 9 wherein the output includes an audio prompt soliciting the spoken input from a user.

11. The method of claim 9 wherein the output includes including visual display to the user.

12. The method of claim 9 wherein monitoring the audio input includes detecting the user's spoken input in the audio input.

13. The method of claim 12 wherein detecting the user's spoken input includes estimating a certainty that the audio input includes the user's spoken input.

14. The method of claim 1 wherein controlling the presentation of the output includes controlling a presentation characteristic in a changing profile over time.

15. The method of claim 14 wherein the output includes an audio output and controlling the presentation characteristic of the output includes attenuating the audio output in a changing profile over time.

16. The method of claim 14 wherein the output includes visual output and controlling the presentation characteristic of the output includes making a transition in the visual output in a changing profile over time.

17. The method of claim 16 wherein making the transition includes fading between one visual output and another visual output.

18. The method of claim 1 wherein controlling the presentation of the output includes repeatedly adjusting a presentation characteristic in response to the monitored audio input.

19. The method of claim 18 wherein controlling the presentation includes adjusting the presentation characteristic at regular intervals.

20. The method of claim 1 wherein monitoring the audio input includes computing a measure of presence of the user's spoken input in the audio input.

21. The method of claim 20 wherein computing the measure of presence of the user's spoken input in the audio input includes computing a measure that the user's spoken input is in a desired grammar.

22. The method of claim 21 wherein the desired grammar comprises a set of commands.

23. The method of claim 20 wherein controlling the presentation of the output includes processing the measure of the presence of the user's spoken input to determine a quantity characterizing a presentation characteristic of the output.

24. The method of claim 23 wherein processing the measure of the presence includes filtering said measure.

25. The method of claim 20 wherein computing the measure of presence of speech include applying a speech recognition approach to determine the measure of presence of speech.

26. The method of claim 1 wherein the output includes an audio output, and controlling the characteristic of the output includes increasing a level of the audio output for at least some audio inputs.

27. A system comprising:
means for monitoring an audio input that includes spoken input from a user; and
means for controlling a presentation of an output presented to the user while monitoring the audio input, the presentation of the output being determined based on the monitoring of the audio input.

28. The system of claim 27 wherein the means for controlling the presentation of the output includes means for controlling a level of an audio output based on the monitoring of the audio input.

29. Software stored on computer-readable media comprising instructions when executed on a processing system cause the system to:
monitor an audio input that includes spoken input from a user; and
control presentation of an output presented to the user while monitoring the audio input, the presentation of the output being determined based on the monitoring of the audio input.

30. The software of claim 29 wherein controlling the presentation of the output includes controlling a level of an audio output based on the monitoring of the audio input.

31. An audio system comprising:
a prompt player;
a gain control module configured to attenuate an output of the prompt player; and
a voice detector configured to accept an audio input and provide a control signal to the gain control module;
wherein the voice detector is configured to provide a control signal that characterizes a measure of presence of a desired signal in the audio input, and the gain control module is configured to attenuate the output of the prompt player according to the measure of presence of the desired signal.

32. The system of claim 31 wherein the audio system includes an interface from use with a telephone system such that the prompt player is configured to play the prompt to a telephone user at a remote handset, and the voice detector is configured to accept the audio input from the remote handset.

33. A method for controlling an output while receiving a user input, comprising:
presenting an output to a user;
monitoring an input from the user; and
controlling presentation of the output to the user while monitoring the input, the presentation of the output being determined based on the monitoring of the input; and
wherein at least one of the output to the user and the input from the user includes visual information.

34. The method of claim 33 wherein monitoring input from the user includes monitoring visual information associated with the user.

35. The method of claim 34 wherein the visual information associated with the user includes facial information of the user.

36. The method of claim 34 wherein the visual information associated with the user includes gesture information.

37. The method of claim 33 wherein controlling presentation of the output includes controlling presentation of visual information to the user.
